(19) United States
(12) Patent Application Publication
(10) Pub. No.: US 2003/0140796 A1
(43) Pub. Date: Jul. 31, 2003

(54) Bread maker with hot air circulation means

(76) Inventor: Donglei Wang, Nanping Town (CN)

Correspondence Address: LADAS & PARRY, 26 WEST 61ST STREET, NEW YORK, NY, 10023, US

(21) Appl. No.: 10/309,755

(22) Filed: Dec. 4, 2002

(30) Foreign Application Priority Data
Jan. 31, 2002 (CN) 02206741.8

(51) Int. Cl. A23L 1/00

(52) U.S. Cl. 99/326

(57) ABSTRACT

A bread maker with hot air circulating means, comprises a housing defining the outer appearance of the bread maker; a baking oven; a bread barrel; a stirring bar; a drive mechanism; a upper assembly; a control panel assembly; a control unit and a circulating means being mounted on the side wall of the baking oven, and the air communication port of the circulating means being disposed on the position adjacent to the inlet and outlet of the baking oven. The circulating means comprises a fan and an air duct. The fan is mounted inside of said air duct and an air communicating port of the air duct is disposed adjacent to the inlet and outlet of the baking oven. The air inlet and outlet of the baking oven are formed on the side wall of the baking oven. The hot air inside of the baking oven is directed into a loop airflow by the rotation of the fan disposed in the circulating means. The bread maker of the present invention allows the bread barrel to be evenly heated and the color of the baked bread is evenly distributed. Moreover, the maker of the present invention is easily put into practical use and is bound to be competitive in the market.

### BACKGROUND OF THE INVENTION

1. Field of the Invention

The present invention relates to a bread maker, more particularly, to a bread maker with a hot air circulation means.

2. The Technical Background

Nowadays, the bread maker has been used as a household appliance by more and more families with the improvement of life of the people. FIG. 1 is a plan view schematically showing the configuration of a conventional bread maker. As shown, the bread maker includes a housing 1, a baking oven 2, a bread barrel 3, an electrical heating tube 4, a stirring bar 5, a drive mechanism 6, a upper cover assembly 7, a control panel assembly 8 and a control unit 9. The electrical heating tube 4 and the bread barrel 3 are disposed inside of the baking oven. The bread in the bread barrel is baked by the heat generated from the electrical heating tube 4. When bread is to be baked, the upper cover is closed and the baking oven is sealed. Therefore, the air in the baking oven does not circulate and the temperature is not evenly distributed throughout the baking oven. Consequently, the bread baked in the conventional bread maker does not have even color. More specifically, the color of the top of the bread is thinner than that of the other parts and the crust of the bread is undesirably thick.

A known bread maker with hot air circulating heater is shown in FIG. 2. Refer to FIG. 2, the bread maker includes a housing, a baking oven, a bread barrel, a stirring bar, a drive mechanism, a upper assembly, a control panel assembly, a control unit. It is characterized that the bread maker further includes a heating unit mounted outside of the baking oven, and the baking oven is provided with an inlet and an outlet adjacent to a sidewall of the baking oven. When power is supplied to the heating unit, the hot air generated by the heating unit is directed into an airflow by the operation of the fan in the heating unit. The airflow is guided into the baking oven through the inlet of the baking oven and the baking oven is filled with hot air, which circulates throughout the baking oven. The circulating air is discharged from the outlet of the baking oven and is heated again by the heating unit. Then the heated hot air is directed into the baking oven and circulation is performed continuously. As the conventional heat device is arranged outside of the baking oven, it is not convenient to fitting the heat device to the baking oven and the heating time is undesirably long while the fan is rotating continuously throughout the heating process. Furthermore, an ambient temperature and a temperature rise occur in the outside part of the baking oven, such as the motor and the control panel.

### SUMMARY OF THE INVENTION

The present invention is made to overcome the above problems and disadvantages of the conventional bread maker without a hot air circulating means and that of the known bread maker with hot air circulating means. In order to accomplish the above and other objects and advantages, the present invention provides a novel bread maker with hot air circulating means which can make the color of the bread baked in it more evenly distributed.

The break maker of the present invention is configured such that the circulating means is mounted outside of baking oven and the air communication port is disposed adjacent to inlet and outlet of the baking oven. The circulating means comprises a fan, a motor and an air duct. The fan is fixed inside of the air duct and the air communication port of the air duct is disposed adjacent to the inlet and outlet of the baking oven. The inlet and outlet of the baking oven are formed on the sidewall of the baking oven. In an embodiment of the present invention, the air is directed into the baking oven by a guide means.

The present invention can be applied to the conventional automatic bread maker which is heated by an electrical heating unit by providing with the air-circulating means which can make the hot air circulates automatically in the baking oven. As the bread maker is provided with an electrical heating unit and the fan circulating means is mounted on one side of the baking oven, the hot air circulates throughout the inside of the baking oven. Consequently, the baking oven, especially the topside in the bread barrel is filled with hot air, thereby the color of the baked bread is evenly distributed, resulting in that the color of the topside of the bread is thickened. Therefore, the color of the topside of the bread is substantially the same with that of the peripheral sides and the color is more evenly distributed throughout the bread. The circulation means of the present invention has many advantages and features, for example, it has simple construction and it can be easily fitted to the baking oven. Further, the reliability of the product is improved and the invention is of much practice use.

### BRIEF DESCRIPTION OF THE DRAWINGS

The above and other objects and disadvantages of the invention will become apparent and readily appreciated from the following description of the preferred embodiments, taken in conjunction with the accompanying drawings of which:

FIG. 1 is a schematic view showing a conventional bread maker without a hot air circulating means;

FIG. 2 is a schematic view showing a conventional bread maker with a hot air circulating means of the related art;

FIG. 2a is a structural schematic view showing the heating unit 10 of FIG. 2;

FIG. 3 is a schematic view of the bread maker according to an embodiment of the present invention;

FIG. 3a is a schematic view showing the circulating means of an embodiment of the present invention;

FIG. 3b is a schematic view showing the circulating means of another embodiment of the present invention;

FIG. 3c is a schematic view showing the circulating means of another embodiment of the present invention; and

FIG. 3d is a schematic view showing the circulating means of another embodiment of the present invention, wherein the hot air is directly guided into the baking oven.

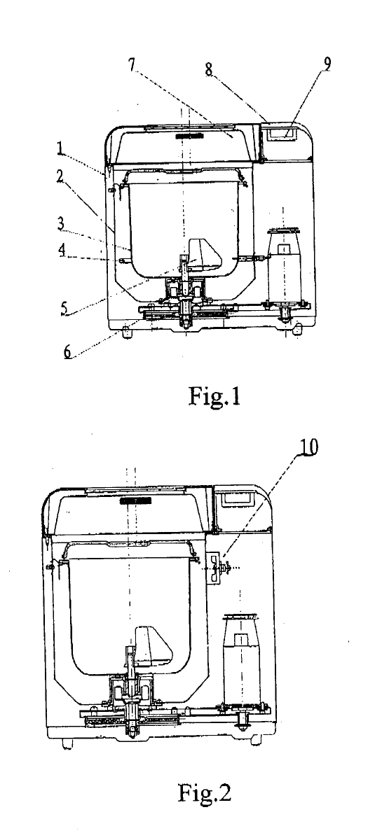

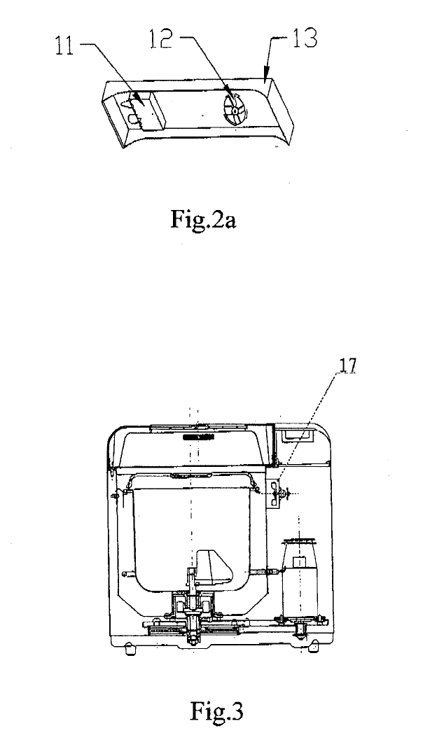

### DETAILED DESCRIPTION OF THE PREFERRED EMBODIMENTS

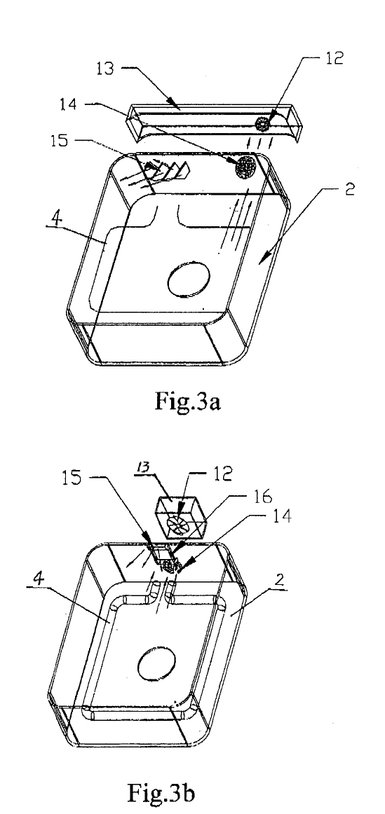

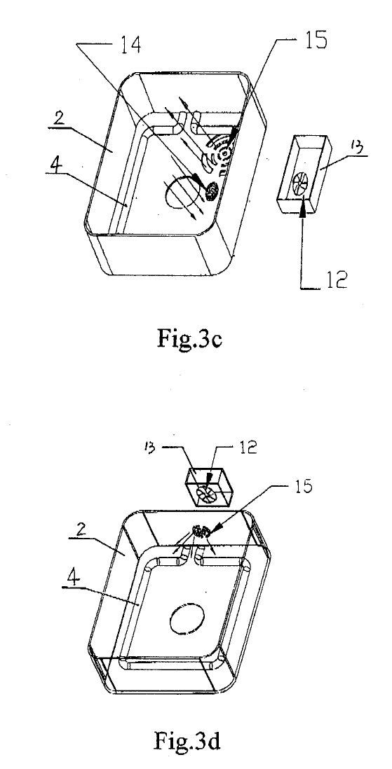

As shown in FIG. 3, the bread maker of the present invention is configured such that the circulating means 17 is mounted outside of baking oven 2 and the air communication port is disposed adjacent to inlet 15 and outlet 14 of the baking oven 2. The circulating means 17 comprises a fan 12 and an air duct 13. The fan 12 is fixed inside of the air duct 13 and the air communication port of the air duct 13 is disposed adjacent to inlet 15 and outlet 14 of the baking oven 2. The inlet 15 and outlet 14 of the baking oven are formed on the wall of the baking oven 2.

Refer to FIG. 3a, the air-circulating means comprises a fan 12 and an air duct 13 and is mounted on the outside of sidewall. The fan 12 is rotated by a motor and the air duct 13 is made of iron sheet while a sheet of mica is formed on the inside of the air duct 13 so that the air duct 13 is isolated from hot air. The inlet 15 and outlet 14 of the baking oven 2 are formed on the sidewall of the baking oven 2. In the embodiment, the outlet 14 of the baking oven 2 is of a Persian blinds shape. It should be noted that the outlet 14 of the baking oven 2 could also be other shapes and the position of it can be adjusted along both the upside and downside direction and the left side and right side direction. The outlet 14 of the baking oven 2 may take circular hole and other various shapes. The electrical heating unit is mounted inside of the baking oven 2. When a bread making operation is carried out, the hot air in the air duct 13 is blown into the baking oven through the inlet 15 by the eccentric force generated by the rotation of the fan 12. Then, the air in the baking oven 2 is sucked outside through the outlet 14 by the negative pressure formed inside of the fan 12. Accordingly, a loop airflow is formed, especially the circulating hot air on the top side makes it possible to make the color of baked bread be evenly distributed. Moreover, the outlet and the inlet may be formed on the bottom of the baking oven or along the diagonal direction, therefore the hot air can blow on the bottom of the baking oven or along the diagonal direction so that circulation of air is achieved as shown in FIG. 3c.

As shown in FIG. 3b, the circulating means comprises a fan 12, heat transmitting case 16 and air duct 13 and the circulating means is mounted on the outside of side wall. The baking oven is formed with an inlet and an outlet. The air passes through the heat transmitting case and one side of the heat transmitting case 16 adjoins the inlet of the baking oven 2 so as to communicate with the air duct 13 and guide the hot air to flow along predetermined path. The fan 12 is mounted on position where the outlet 14 is formed. When a bread making operation is carried out, the fan 12 rotates. Then, the air in the baking oven 2 is sucked outside through the outlet 14 by the negative pressure formed inside of the fan 12. Meanwhile, the hot air is blown into the appropriate position in the baking oven 2 through the opening at one side thereof (i.e. the inlet 15) along the heat transmitting case 16 by the eccentric force. Consequently, a loop airflow is formed, which makes it possible to make the color of baked bread be evenly distributed. It should be noted that the heat transmitting case 16 may have a tube shape or other various kind of shapes and it can be made of high temperature resistant, safety and hygienic materials such as coated aluminum plate or PBT+G30.

FIG. 3d shows a hot air circulation means according to another embodiment of the present invention, wherein the fan 12 driven by the motor blows directly into the baking oven 2. In this embodiment, only the inlet 15 is provided in the baking oven 2 and the fan 12 mounted on the sidewall of the baking oven 2 blows directly into the inlet 15. It can be appreciated that the position of the fan 12 which is mounted on the side wall of the baking oven 2 can be adjusted along both the upside and downside direction and left side and right side direction. In addition, the fan 12 may be mounted on the bottom of the baking oven 2 and blows downside from the upper cover. The hot air can be directed into the appropriate position of the bread barrel by the heat transmitting case 16 and the color of the bread can be more evenly distributed. The heat transmitting case 16 may be rectangular shape, tubular shape or other various shapes and it can be made of high temperature resistant, safety and hygienic materials. The heat transmitting case 16 is disposed inside the opening of the air inlet 15 of the baking oven 2.

1. A bread maker with hot air circulating means, comprising:
a housing defining the outer appearance of the bread maker;
a baking oven;
a bread barrel;
a stirring bar;
a drive mechanism;
a upper assembly;
a control panel assembly;
a control unit;
wherein a circulating means being mounted on the side wall of the baking oven, and the air communication port of the circulating means being disposed on the position adjacent to the inlet and outlet of the baking oven.

2. The bread maker with hot air circulating means according to claim 1, wherein the circulating means comprises:
a fan and an air duct; and
said fan being mounted inside of said air duct and an air communicating port of said air duct being disposed adjacent to the inlet and outlet of the baking oven.

3. The bread maker with hot air circulating means according to claim 1, wherein the air inlet and outlet of the baking oven is formed on the side wall of said baking oven.

4. The bread maker with hot air circulating means according to claim 1, wherein the circulating means comprises:
a fan and an air duct;
wherein the circulating means being mounted on the outside of the side wall of said baking oven;
the fan being driven by a motor;
the air duct being made of heat resistant materials; and
the air inlet and outlet of the baking oven being formed on the side wall of said baking oven.

5. The bread maker with hot air circulating means according to claim 1, wherein the air circulating means is arranged at the peripheral sides of said housing or the bottom of the baking oven or along the diagonal direction.

6. The bread maker with hot air circulating means according to claim 1, wherein the circulating means comprises:
a fan and an air duct;
wherein the circulating means being mounted on the outside of the side wall of said baking oven;
a heat transmitting case communicating with inlet of said baking oven; and said fan being mounted on the position of the outlet of the baking oven.

7. The bread maker with hot air circulating means according to claim 1, wherein the air inlet and outlet are arranged on the bottom of the baking oven or along the diagonal direction.

8. The bread maker with hot air circulating means according to claim 1, wherein the air inlet is formed on baking oven and said fan directly blows hot air into said baking oven, and the air circulating means adjacent to said inlet is arranged on the outside of said baking oven.

9. The bread maker with hot air circulating means according to claim 8, wherein the air circulating means is arrange on the wall of said baking oven or at the bottom or on said upper cover.

10. The bread maker with hot air circulating means according to claim 8, wherein a heat transmitting means is mounted on inside wall of the baking oven corresponding to the inlet of said baking oven and has a rectangular or tubular shape.
